(19) United States
(12) Patent Application Publication
(10) Pub. No.: US 2009/0131462 A1
(43) Pub. Date: May 21, 2009

(54) Fungicidally Active Agent

(75) Inventors: Markus Gewehr, Kastellaun (DE); Reinhard Stierl, Freinsheim (DE); Horst Dieter Brix, Landau (DE); Thomas Grote, Wachenheim (DE); Siegfried Strathmann, Limburgerhof (DE); Maria Scherer, Landau (DE); Frank Werner, Neustadt (DE)

Correspondence Address: BIRCH STEWART KOLASCH & BIRCH, PO BOX 747, FALLS CHURCH, VA, 22040-0747, US

(73) Assignee: BASF AKTIENGESELLSCHAFT, Ludwigshafen (DE)

(21) Appl. No.: 11/988,471

(22) PCT Filed: Jul. 21, 2006
(86) PCT No.: PCT/EP2006/064508

§ 371 Date: Jan. 8, 2008

(30) Foreign Application Priority Data
Jul. 21, 2005 (DE) 10 2005 034 157.8

(51) Int. Cl. A01N 43/54; A01N 43/56; A01N 43/78; A01N 43/80; A01N 43/50; A01P 3/00; A01N 43/76; A01N 43/653; A01N 43/40

(52) U.S. Cl. 514/274; 514/406; 514/370; 514/372; 514/384; 514/340; 514/376; 514/386

(57) ABSTRACT

The invention relates to a fungicidally active agent containing at least one other defined fungicide in addition to the fungicide N-[2-(1,3-dimethylbutyl)-3-thienyl]-1-methyl-3-(trifluormethyl)-1H-pyrazol-4-carboxamide (penthiopyrad). The invention also relates to a method for controlling pathogenic fungi using one such agent, and to the use of said agent for controlling pathogenic fungi.

The present invention relates to a fungicidally active composition which comprises, in addition to the fungicide N-[2-(1,3-dimethylbutyl)-3-thienyl]-1-methyl-3-(trifluoromethyl)-1H-pyrazole-4-carboxamide (penthiopyrad), at least one particular further fungicide, and to a method for controlling harmful fungi using such a composition and to the use of such a composition for controlling harmful fungi.

N-[2-(1,3-Dimethylbutyl)-3-thienyl]-1-methyl-3-(trifluoromethyl)-1H-pyrazole-4-carboxamide, which is also known under the common name penthiopyrad, is described as a highly effective fungicide, for example in EP-A-0737682. The other active compounds used in the composition according to the invention are also known fungicides.

According to experience, when fungicides are used individually, their effect is frequently only temporary, i.e. after a certain period of time renewed growth of harmful fungi can be observed. Furthermore, some harmful fungi develop resistance against individual active compounds.

In the case of crop protection compositions, it is desirable in principle to increase the specific activity of an active compound and the reliability of the effect. It is particularly desirable for the active compound, for example a fungicide, to effectively control the damaging factors, for example harmful fungi, but at the same time to be compatible with the useful plants in question. In this context, it is thus desirable if the active compounds can be employed in application rates which are as low as possible, to achieve a compatibility with useful plants which is as high as possible, and also to keep crop protection agent residues, for example fungicide residues, in plant products as low as possible. At the same time, the effectiveness of the crop protection compositions should of course be as high as possible.

Accordingly, it is an object of the present invention to improve the activity of penthiopyrad in the control of harmful fungi and/or increase the activity of conventional fungicides.

Surprisingly, it has been found that this object is achieved by using penthiopyrad in combination with particular fungicides.

Accordingly, the invention provides a fungicidally active composition, comprising:

A) N-[2-(1,3-dimethylbutyl)-3-thienyl]-1-methyl-3-(trifluoromethyl)-1H-pyrazole-4-carboxamide of the formula A

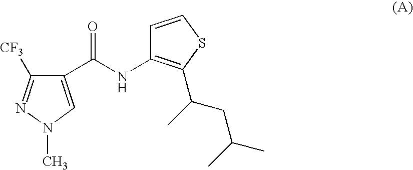

and

B) at least one further fungicide B selected from

B.1) azole fungicides selected from the group consisting of prothioconazole, triticonazole, tetraconazole, flutriafol, imazalil, simeconazole, oxpoconazole, triadimefon, cyazofamid, fuberidazole and ethaboxam;

B.2) carboxamide fungicides;

B.3) heterocyclic compounds different from the azole fungicides of group B.1);

B.4) carbamate and dithiocarbamate fungicides selected from the group consisting of metiram, propamocarb, propamocarb hydrochloride, iprovalicarb, benthiavalicarb, the carbamate of the formula B.4.1

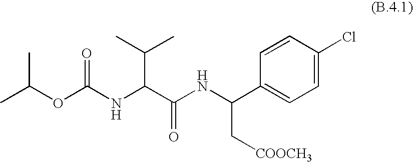

and 4-fluorophenyl N-(1-(1-(4-cyanophenyl)ethanesulfonyl)but-2-yl)carbamate of the formula B.4.2

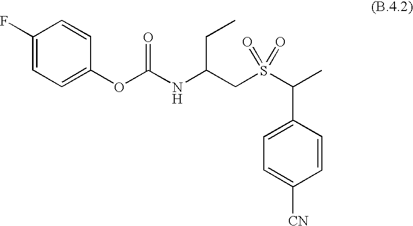

and

B.5) other fungicides selected from

B.5.1) sulfur-containing heterocyclyl compounds;

B.5.2) organophosphorus compounds;

B.5.3) organochlorine compounds;

B.5.4) other fungicides selected from the group consisting of spiroxamine, cyflufenamid and metrafenone.

The composition according to the invention may be a mixture of the compound A and at least one fungicide B. Accordingly, the invention also provides a mixture comprising the compound A and at least one fungicide B. However, the composition may also be any combination of the compound A with at least one fungicide B, it not being required for A and B to be present together in the same formulation.

An example of a composition according to the invention in which the compound A and the at least one fungicide B are not present together in the same formulation is a two-component kit. Accordingly the present invention also relates to a two-component kit, comprising a first component comprising the fungicide A), a liquid or solid carrier and, if appropriate, at least one surfactant and/or at least one customary auxiliary, and a second component comprising at least one fungicide B), a liquid or solid carrier and, if appropriate, at least one surfactant and/or at least one customary auxiliary. Suitable liquid and solid carriers, surfactants and customary auxiliaries are described below.

Moreover, the invention relates to a method for controlling harmful fungi, which comprises allowing the compound A in combination with at least one fungicide of group B) or a composition according to the invention, which comprises the compound A and at least one fungicide B, to act on the fungi, their habitat or the materials, plants, seed, soils, areas or spaces to be protected against fungal attack. Here, the application of active compounds A and B can be either simultaneously, that is jointly or separately, or in succession.

Furthermore, the invention relates to the use of the compound A in combination with at least one fungicide of group B) or of a composition according to the invention, which comprises the compound A and at least one fungicide B, for controlling harmful fungi.

The specifications given below for suitable and preferred embodiments of the compound A, the fungicide B and the compositions comprising them and their use apply both on their own and, preferably, in combination with one another.

Suitable according to the invention are both the racemate of penthiopyrad of the formula A and its enantiomers, and nonracemic mixtures of these enantiomers.

The azole fungicides B.1) are compounds comprising at least one aromatic nitrogenous heterocycle, for example at least one pyrrole, pyrazole, imidazole, triazole, oxazole, thiazole, benzimidazole, pyridine or pyrimidine ring.

The carboxamide fungicides B.2) are preferably selected from the group consisting of zoxamide, fluopicolide, thifluzamide, carboxin, boscalid, fenhexamid, tiadinil, flumorph, mandipropamid, fenoxanil, silthiofam, N-(2-(4-[3-(4-chlorophenyl)prop-2-ynyloxy]-3-methoxyphenyl)ethyl)-2-methylsulfonylamino-3-methylbutyramide of the formula B.2.1 (R=methyl), N-(2-(4-[3-(4-chlorophenyl)prop-2-ynyloxy]-3-methoxyphenyl)ethyl)-2-ethylsulfonylamino-3-methylbutyramide of the formula B.2.1 (R=ethyl)

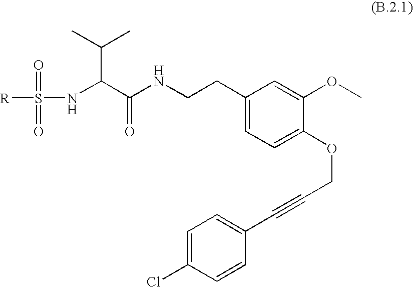

(R=methyl, ethyl)
and N-(2-cyanophenyl)-3,4-dichloroisothiazole-5-carboxamide of the formula B.2.2

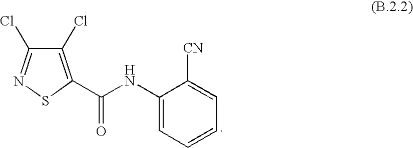

The heterocyclic compounds B.3) are compounds which do not belong to the azole fungicides B.1). These include compounds containing, for example, at least one saturated or partially unsaturated nonaromatic nitrogenous heterocycle, for example at least one pyrroline, pyrrolidine, pyrrolidone, pyrazoline, pyrazolinone, pyrazolidine, pyrazolidinone, pyrazolidindione, imidazoline, imidazolidine, imidazolidinone, oxazoline, oxazolidine, oxazolidinone, thiazoline, thiazolidine, piperidine or morpholine ring and the like. Also included are compounds containing, for example, at least one aromatic or nonaromatic nitrogen-free mono- or polycyclic heterocycle, for example at least one furan, di- or tetrahydrofuran, thiophene, chromene or chromenone ring and the like.

The heterocyclic compounds B.3) are preferably selected from the group consisting of famoxadone, fenamidone, proquinazid, acibenzolar-S-methyl, 2-butoxy-6-iodo-3-propylchromen-4-one of the formula B.3.1

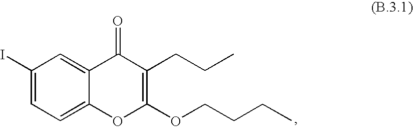

N, N-dimethyl-3-(3-bromo-6-fluoro-2-methylindole-1-sulfonyl)[1,2,4]triazole-1-sulfonamide of the formula B.3.2

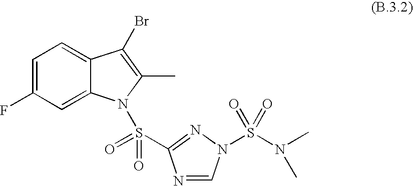

and 3-[5-(4-chlorophenyl)-2,3-dimethylisoxazolidin-3-yl]pyridine of the formula B.3.3

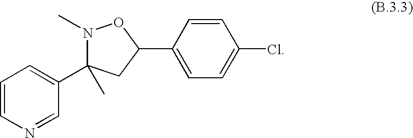

A particularly preferred (dithio)carbamate fungicide is metiram.

The sulfur-containing heterocyclyl compound B.5.1) is preferably dithianon.

The organophosphorus compound B.5.2) is preferably tolclofos-methyl.

The organochlorine compounds B.5.3) are preferably selected from the group consisting of flusulfamide and tolylfluanid.

If the fungicides of component B) form geometrical isomers, for example E/Z isomers, it is possible to use both the pure isomers and mixtures thereof in the compositions according to the invention. If these compounds have one or more centers of chirality and may thus be present as enantiomers or diastereomers, it is possible to use both the pure enantiomers and the diastereomers and mixtures thereof in the compositions according to the invention.

If the fungicides of component A) and B) have ionizable functional groups, they can also be employed in the form of their agriculturally acceptable salts. Thus, when they have basic functional groups, for example, they can be employed in the form of their acid addition salts. In general, the acid addition salts of those acids whose anions do not have any negative effect on the action of the active compounds are suitable.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate, and also the anions of C₁-C₄-alkanoic acids, preferably formate, acetate, propionate and butyrate.

The following active compounds, for example, can be used in the form of acid addition salts: penthiopyrad of the formula A, fenamidone, triticonazole, tetraconazole, flutriafol, imazalil, semiconazole, triadimefon, fuberidazole, ethaboxam, acibenzolar-S-methyl, spiroxamine, propamocarb, and also the compound of the formula B.3.3.

Processes for preparing penthiopyrad of the formula A (component A) are known and described, for example, in EP-A-737682 or EP-A-1036793, which are included herein in their entirety by way of reference.

The active compounds of component B are likewise known fungicides whose preparation processes are known from the prior art.

Thus, benthiavalicarb and processes for their preparation are described, for example, in Agrow 417 (2003), the content of which is included herein in its entirety by way of reference.

Simeconazole and processes for their preparation are described, for example, in Agrow 324, 26 (1999), the content of which is included herein in its entirety by way of reference.

Triticonazole and processes for its preparation are described, for example, in Agrow 166, 24 (1992), the content of which is included herein in its entirety by way of reference.

Cyflufenamid and processes for its preparation are described, for example, in Agrow 408, 6 (2002), the content of which is included herein in its entirety by way of reference.

Metrafenone and boscalid and processes for their preparation are described, for example, in Agrow 384, 22 (2001), the content of which is included herein in its entirety by way of reference.

Flumorph and processes for its preparation are described, for example, in Agrow 452, 22 (2004), the content of which is included herein in its entirety by way of reference.

Fluopicolide and processes for its preparation are described, for example, in WO 99/42447, the content of which is included herein in its entirety by way of reference.

The following fungicides and processes for their preparation are described in Crop Protection Handbook, Volume 89, Meister Publishing, USA 2003, the content of which is included herein in its entirety by way of reference: famoxadone (page C 217), fenamidone (page C 219), metiram (page C 321), prothioconazole (page C 394), tetraconazole (page C 449), flutriafol (page C 241), imazalil (page C 269), triadimefon (page C 464), iprovalicarb (page C 277), proquinazid (page C 394), fuberidazole (page C 247), thifluzamide (page C 453), carboxin (page C 104), dithianon (page C 193), fenhexamid (page C 221), zoxamide (page C 490), ethaboxam (page C 209), acibenzolar-S-methyl (page C 35), spiroxamine (page C 429), tolylfluanid (page C 461), silthiofam (page C 421), fenoxanil (page C 222), propamocarb and also propamocarb hydrochloride (page C 387) and tolclofos-methyl (page C 460).

Cyazofamid and processes for its preparation are described, for example, in Pest Manag. Sci. 58, 139 (2001), which is included herein in its entirety by way of reference.

The carboxamide of the formula B.4.1 and processes for its preparation are described, for example, in EP-A-1028125 and WO 02/006304, which are included herein in their entirety by way of reference.

The compounds of the formula B.2.1 in which R is methyl or ethyl and processes for their preparation are described, for example, in WO 2004/049804, which is included herein in its entirety by way of reference.

The compound of the formula B.3.2 and processes for its preparation are described, for example, in U.S. Pat. No. 6,620,812 and also in WO 03/053145, which are included herein in their entirety by way of reference.

The compound of the formula B.3.1 and processes for its preparation are described, for example, in WO 03/14103, which is included herein in its entirety by way of reference.

The compound of the formula B.3.3 and processes for its preparation are described, for example, in EP-A-1035122, which is included herein in its entirety by way of reference.

The compound of the formula B.2.2 and processes for its preparation are described, for example, in WO 2005/009130 and in WO 2005/009131, which are included herein in their entirety by way of reference.

The compound of the formula B.4.2 and processes for its preparation are described, for example, in WO 2005/009130 and in WO 2004/052102, which are included herein in their entirety by way of reference.

Mandipropamid and processes for its preparation are described, for example, in WO 01/87822 and in WO 03/041728, which are included herein in their entirety by way of reference.

In the composition according to the invention, the fungicidally active components A and B are employed advantageously in a synergistically effective amount, i.e. in a weight ratio such that a synergistic effect takes place. “Synergistic effect” means that the fungicidal effect on at least one harmful fungus is increased in a super additive manner; i.e. the increase of the fungicidal effectiveness is significantly more pronounced than would have been expected based on the fungicidal effectiveness of the individual active compounds. Expected efficacies of active compound combinations can be determined, for example, using Colby formula (S. R. Colby, Calculating Synergistic and Antagonistic Response of Herbicide Combinations, Weeds, 15, pp. 20-22).

Preferably, the weight ratio of component A to component B is from 200:1 to 1:200, more preferably from 100:1 to 1:100, e.g. from 2:1 to 1: 100, particularly preferably from 75:1 to 1:75, e.g. from 2:1 to 1:75 and in particular from 10:1 to 1:10, e.g. from 2:1 to 1:10.

In a special embodiment of the invention, the fungicide B is selected from fungicides of groups B.2), B.3), B.4) and B.5) and mixtures thereof.

In an alternative special embodiment of the invention, the mixture comprises, as fungicide B, at least one fungicide of group B.1) (azoles) and, if appropriate, at least one further fungicide selected from fungicides of groups B.2), B.3), B.4), B.5) and mixtures thereof.

In preferred embodiments of the invention, the mixture comprises, as fungicide B, at least one fungicide of group B.4) ((dithio)carbamates) and, if appropriate, at least one further fungicide selected from fungicides of groups B.1), B.2), B.3), B.5) and mixtures thereof.

The compositions according to the invention can be both binary and ternary or higher compositions. In the context of the present invention, binary compositions are to be understood as meaning those which, as fungicidally active compounds, comprise, in addition to the compound of the formula A, only one further fungicide from group B. Correspondingly, ternary compositions are those which, as fungicidally active compounds, comprise, in addition to component A, two different fungicides from group B. Consequently, higher compositions comprise three or more fungicides from group B.

Examples of preferred binary compositions are listed in Table 1.

TABLE 1
Binary compositions comprising the compound of
the formula A and a fungicide from group B

| | | Weight ratio |
|---|---|---|
| Composition | Fungicide of group B | Compound A:compound B |
| 1. | prothioconazole | 100:1 to 1:100, particularly |
| | | preferably 50:1 to |
| | | 1:50, especially 10:1 to 1:10 |
| 2. | triticonazole | 100:1 to 1:100, particularly |
| | | preferably 50:1 to |
| | | 1:50, especially 10:1 to 1:10 |
| 3. | tetraconazole | 100:1 to 1:100, particularly |
| | | preferably 50:1 to |
| | | 1:50, especially 10:1 to 1:10 |
| 4. | flutriafol | 100:1 to 1:100, particularly |
| | | preferably 50:1 to |
| | | 1:50, especially 10:1 to 1:10 |
| 5. | imazalil | 100:1 to 1:100, particularly |
| | | preferably 50:1 to |
| | | 1:50, especially 10:1 to 1:10 |
| 6. | simeconazole | 100:1 to 1:100, particularly |
| | | preferably 50:1 to |
| | | 1:50, especially 10:1 to 1:10 |
| 7. | oxpoconazole | 100:1 to 1:100, particularly |
| | | preferably 50:1 to |
| | | 1:50, especially 10:1 to 1:10 |
| 8. | triadimefon | 100:1 to 1:100, particularly |
| | | preferably 50:1 to |
| | | 1:50, especially 10:1 to 1:10 |
| 9. | cyazofamid | 100:1 to 1:100, particularly |
| | | preferably 50:1 to |
| | | 1:50, especially 10:1 to 1:10 |
| 10. | fuberidazole | 100:1 to 1:100, particularly |
| | | preferably 50:1 to |
| | | 1:50, especially 10:1 to 1:10 |
| 11. | ethaboxam | 100:1 to 1:100, particularly |
| | | preferably 50:1 to |
| | | 1:50, especially 10:1 to 1:10 |
| 12. | zoxamide | 100:1 to 1:100, particularly |
| | | preferably 50:1 to |
| | | 1:50, especially 10:1 to 1:10 |
| 13. | fluopicolide | 100:1 to 1:100, particularly |
| | | preferably 50:1 to |
| | | 1:50, especially 10:1 to 1:10 |
| 14. | thifluzamide | 100:1 to 1:100, particularly |
| | | preferably 50:1 to |
| | | 1:50, especially 10:1 to 1:10 |
| 15. | carboxin | 100:1 to 1:100, particularly |
| | | preferably 50:1 to |
| | | 1:50, especially 10:1 to 1:10 |
| 16. | boscalid | 100:1 to 1:100, particularly |
| | | preferably 50:1 to |
| | | 1:50, especially 10:1 to 1:10 |
| 17. | fenhexamid | 100:1 to 1:100, particularly |
| | | preferably 50:1 to |
| | | 1:50, especially 10:1 to 1:10 |
| 18. | tiadinil | 100:1 to 1:100, particularly |
| | | preferably 50:1 to |
| | | 1:50, especially 10:1 to 1:10 |
| 19. | flumorph | 100:1 to 1:100, particularly |
| | | preferably 50:1 to |
| | | 1:50, especially 10:1 to 1:10 |
| 20. | mandipropamid | 100:1 to 1:100, particularly |
| | | preferably 50:1 to |
| | | 1:50, especially 10:1 to 1:10 |
| 21. | fenoxanil | 100:1 to 1:100, particularly |
| | | preferably 50:1 to |
| | | 1:50, especially 10:1 to 1:10 |
| 22. | silthiofam | 100:1 to 1:100, particularly |
| | | preferably 50:1 to |
| | | 1:50, especially 10:1 to 1:10 |
| 23. | compound of the | 100:1 to 1:100, particularly |
| | formula B.2.1 (R = | preferably 50:1 to |
| | methyl) | 1:50, especially 10:1 to 1:10 |
| 24. | compound of the | 100:1 to 1:100, particularly |
| | formula B.2.1 (R = | preferably 50:1 to |
| | ethyl) | 1:50, especially 10:1 to 1:10 |
| 25. | compound of the | 100:1 to 1:100, particularly |
| | formula B.2.2 | preferably 50:1 to |
| | | 1:50, especially 10:1 to 1:10 |
| 26. | famoxadone | 100:1 to 1:100, particularly |
| | | preferably 50:1 to |
| | | 1:50, especially 10:1 to 1:10 |
| 27. | fenamidone | 100:1 to 1:100, particularly |
| | | preferably 50:1 to |
| | | 1:50, especially 10:1 to 1:10 |
| 28. | proquinazid | 100:1 to 1:100, particularly |
| | | preferably 50:1 to |
| | | 1:50, especially 10:1 to 1:10 |
| 29. | acibenzolar-S-methyl | 100:1 to 1:100, particularly |
| | | preferably 50:1 to |
| | | 1:50, especially 10:1 to 1:10 |
| 30. | 2-butoxy-6-iodo-3- | 100:1 to 1:100, particularly |
| | propylchromen-4-one | preferably 50:1 to |
| | | 1:50, especially 10:1 to 1:10 |
| 31. | compound of the | 100:1 to 1:100, particularly |
| | formula B.3.2 | preferably 50:1 to |
| | | 1:50, especially 10:1 to 1:10 |
| 32. | compound of the | 100:1 to 1:100, particularly |
| | formula B.3.3 | preferably 50:1 to |
| | | 1:50, especially 10:1 to 1:10 |
| 33. | metiram | 100:1 to 1:100, particularly |
| | | preferably 50:1 to |
| | | 1:50, especially 10:1 to 1:10 |
| 34. | propamocarb | 100:1 to 1:100, particularly |
| | hydrochloride | preferably 50:1 to |
| | | 1:50, especially 10:1 to 1:10 |
| 35. | iprovalicarb | 100:1 to 1:100, particularly |
| | | preferably 50:1 to |
| | | 1:50, especially 10:1 to 1:10 |
| 36. | benthiavalicarb | 100:1 to 1:100, particularly |
| | | preferably 50:1 to |
| | | 1:50, especially 10:1 to 1:10 |
| 37. | compound of the | 100:1 to 1:100, particularly |
| | formula B.4.1 | preferably 50:1 to |
| | | 1:50, especially 10:1 to 1:10 |
| 38. | compound of the | 100:1 to 1:100, particularly |
| | formula B.4.2 | preferably 50:1 to |
| | | 1:50, especially 10:1 to 1:10 |
| 39. | dithianon | 100:1 to 1:100, particularly |
| | | preferably 50:1 to |
| | | 1:50, especially 10:1 to 1:10 |
| 40. | tolclofos-methyl | 100:1 to 1:100, particularly |
| | | preferably 50:1 to |
| | | 1:50, especially 10:1 to 1:10 |
| 41. | flusulfamide | 100:1 to 1:100, particularly |
| | | preferably 50:1 to |
| | | 1:50, especially 10:1 to 1:10 |
| 42. | tolylfluanid | 100:1 to 1:100, particularly |
| | | preferably 50:1 to |
| | | 1:50, especially 10:1 to 1:10 |
| 43. | spiroxamine | 100:1 to 1:100, particularly |
| | | preferably 50:1 to |
| | | 1:50, especially 10:1 to 1:10 |
| 44. | cyflufenamid | 100:1 to 1:100, particularly |
| | | preferably 50:1 to |
| | | 1:50, especially 10:1 to 1:10 |
| 45. | metrafenone | 100:1 to 1:100, particularly |
| | | preferably 50:1 to |
| | | 1:50, especially 10:1 to 1:10 |

In ternary compositions, too, compound A and the two fungicides from group B are employed in ratios such that a synergistic effect within the meaning of the above definition takes place. Preferably, in ternary compositions the ratio of the weight of compound A to the total weight of the two fungicides from group B is from 100:1 to 1:100, particularly preferably from 50:1 to 1:50 and especially from 10:1 to 1:10. Here, the weight ratio of the two fungicides from group B is preferably 100:1 to 1:100, particularly preferably from 50:1 to 1:50 and especially from 10:1 to 1:10.

In addition to the compound A, preferred ternary compositions comprise two further fungicides B selected from the group consisting of prothioconazole, triticonazole, tetraconazole, flutriafol, imazalil, simeconazole, oxpoconazole, triadimefon, cyazofamid, fuberidazole, ethaboxam, zoxamide, fluopicolide, thifluzamide, carboxin, boscalid, fenhexamid, tiadinil, flumorph, mandipropamid, fenoxanil, silthiofam, the compound of the formula B.2.1 (R=methyl), the compound of the formula B.2.1 (R=ethyl), the compound of the formula B.2.2, famoxadone, fenamidone, proquinazid, acibenzolar-S-methyl, 2-butoxy-6-iodo-3-propylchromen-4-one, the compound of the formula B.3.2, the compound of the formula B.3.3, metiram, propamocarb hydrochloride, iprovalicarb, benthiavalicarb, the compound of the formula B.4.1, the compound of the formula B.4.2, dithianon, tolclofos-methyl, flusulfamide, tolylfluanid, spiroxamine, cyflufenamid and metrafenone.

Particularly preferred compositions comprise, in addition to compound A, metiram and if appropriate a further fungicide B.

In the ready-to-use preparations, for example in the compositions according to the invention in the form of crop protection compositions, the components A and B can be present formulated jointly or separately, in suspended, emulsified or dissolved form. The application forms depend entirely on the intended uses.

The fungicides A and B of the compositions according to the invention can be applied as such, in the form of their formulations or the application form prepared therefrom, for example in the form of directly sprayable solutions, powders, suspensions or dispersions, including highly concentrated aqueous, oily or other suspensions or dispersions, emulsions, oil dispersions, pastes, dusts, compositions for broadcasting or granules. Application is usually by spraying, atomizing, dusting, broadcasting or watering. The application forms and methods depend on the intended uses; in each case, they should ensure the finest possible distribution of the active compounds.

Depending on the embodiment in which the ready-to-use preparations of the compositions according to the invention are present, they comprise one or more liquid or solid carriers, if appropriate surfactants and if appropriate further auxiliaries customary for formulating crop protection agents. The recipes for such formulations are familiar to the person skilled in the art.

Aqueous application forms can be prepared, for example, from emulsion concentrates, suspensions, pastes, wettable powders or water-dispersible granules by addition of water. To prepare emulsions, pastes or oil dispersions, the active compounds A and B, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, such concentrates being suitable for dilution with water.

The concentrations of fungicides A and B in the ready-to-use preparations can be varied within relatively wide ranges. In general, they are between 0.0001 and 10%, preferably between 0.01 and 1% (% by weight total content of active compound, based on the total weight of the ready-to-use preparation).

The fungicides A and B may also be used successfully in the ultra-low-volume process (ULV), it being possible to employ formulations comprising more than 95% by weight of active compound, or even to apply the active compounds without additives.

Oils of various types, wetting agents, adjuvants, herbicides, fungicides different from active compounds A and B, insecticides, nematicides, other pesticides, such as bactericides, fertilizers and/or growth regulators may be added to the active compounds, even, if appropriate, not until immediately prior to use (tank mix). These agents can be mixed in a weight ratio of from 1:100 to 100:1, preferably from 1:10 to 10:1 with the active compounds A and B employed according to the invention.

Suitable adjuvants in this sense are in particular: organically modified polysiloxanes, for example Break Thru S 240®|; alcohol alkoxylates, for example Atplus 245®, Atplus MBA 1303®, Plurafac LF 300® and Lutensol ON 30®; EP/PO block polymers, for example Pluronic RPE 2035® and Genapol B®; alcohol ethoxylates, for example Lutensol XP 80®; and sodium dioctylsulfosuccinate, for example Leophen RA®.

In many cases, the joint application of the fungicides A and B employed according to the invention with other fungicides results in a widening of the fungicidal activity spectrum.

The following list of fungicides which can be employed together with the active compounds A and B employed according to the invention is meant to illustrate the possible combinations, but not to limit them:

acylalanines, such as benalaxyl, metalaxyl, ofurace, oxadixyl;

amine derivatives, such as aldimorph, dodine, dodemorph, fenpropimorph, fenpropidin, guazatine, iminoctadine, tridemorph;

anilinopyrimidines, such as pyrimethanil, mepanipyrim or cyprodinyl;

antibiotics, such as cycloheximide, griseofulvin, kasugamycin, natamycin, polyoxin or streptomycin;

azoles different from group B.1), such as bitertanol, bromoconazole, cyproconazole, difenoconazole, dinitroconazole, epoxiconazole, fenbuconazole, fluquinconazole, flusilazole, flutriafol, hexaconazole, metconazole, myclobutanil, penconazole, propiconazole, prochloraz, tebuconazole, triflumizole;

dicarboximides, such as iprodione, myclozolin, procymidone, vinclozolin;

dithiocarbamates, such as ferbam, nabam, maneb, mancozeb, metam, propineb, polycarbamate, thiram, ziram, zineb;

heterocyclic compounds, such as anilazine, benomyl, carbendazim, dazomet, fenarimol, flutolanil, furametpyr, isoprothiolane, mepronil, nuarimol, probenazole, pyrifenox, pyroquilon, quinoxyfen, thiophanate-methyl, tricyclazole, triforine;

copper fungicides, such as Bordeaux mixture, copper acetate, copper oxychloride, basic copper sulfate;

nitrophenyl derivatives, such as binapacryl, dinocap, dinobuton, nitrophthal-isopropyl;

phenylpyrroles, such as fenpiclonil or fludioxonil;

sulfur;

other fungicides, such as carpropamid, chlorothalonil, cymoxanil, diclomezine, diclocymet, diethofencarb, edifenphos, fentin-acetate, ferimzone, fluazinam, fosetyl, fosetyl-aluminum, hexachlorobenzene, pencycuron, phthalide, quintozene;

strobilurins, such as azoxystrobin, dimoxystrobin, enestroburin, fluoxastrobin, kresoxim-methyl, metominostrobin, orysastrobin, picoxystrobin, pyraclostrobin or trifloxystrobin;

sulfenic acid derivatives, such as captafol, captan, dichlofluanid, folpet;

cinnamides and analogs, such as dimethomorph, flumetover.

In a special embodiment of the invention, the composition according to the invention comprises only the compound A and the at least one fungicide B as fungicidally active components.

The formulations are prepared in a known manner, for example by extending the active compound/the active compounds with solvents and/or carriers, if desired with the use of surfactants, i.e. emulsifiers and dispersants. Solvents/carriers suitable for this purpose are essentially:

water, aromatic solvents (for example Solvesso products, xylene), paraffins (for example mineral oil fractions), alcohols (for example methanol, butanol, pentanol, benzyl alcohol), ketones (for example cyclohexanone, methyl hydroxybutyl ketone, diacetone alcohol, mesityl oxide, isophorone), lactones (for example gamma-butyrolactone), pyrrolidones (pyrrolidone, N-methylpyrrolidone, N-ethylpyrrolidone, n-octylpyrrolidone), acetates (glycol diacetate), glycols, dimethyl fatty acid amides, fatty acids and fatty acid esters. In principle, solvent mixtures may also be used.

Carriers such as ground natural minerals (for example kaolins, clays, talc, chalk) and ground synthetic minerals (for example finely divided silica, silicates); emulsifiers such as nonionic and anionic emulsifiers (for example polyoxyethylene fatty alcohol ethers, alkylsulfonates and arylsulfonates), and dispersants such as lignosulfite waste liquors and methylcellulose.

Suitable surfactants are alkali metal salts, alkaline earth metal salts and ammonium salts of lignosulfonic acid, naphthalenesulfonic acid, phenolsulfonic acid, dibutyinaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenyl polyglycol ether, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Suitable for the preparation of directly sprayable solutions, emulsions, pastes or oil dispersions are mineral oil fractions of medium to high boiling point, such as kerosene or diesel oil, furthermore coal tar oils and oils of vegetable and animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, mesityl oxide, isophorone, strongly polar solvents, for example dimethyl sulfoxide, 2-pyrrolidone, N-methylpyrrolidone, butyrolactone, or water.

Powders, compositions for broadcasting and dusts can be prepared by mixing or jointly grinding the active substances with a solid carrier.

Granules, for example coated granules, impregnated granules and homogeneous granules, can be prepared by binding the active compounds onto solid carriers. Solid carriers are, for example, mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and plant products such as cereal meal, tree bark meal, wood meal and nutshell meal, cellulose powder and other solid carriers.

Formulations for the treatment of seed may additionally comprise binders and/or gelling agents and, if appropriate, colorants.

In general, the formulations comprise from 0.01 to 95% by weight, preferably from 0.1 to 90% by weight, in particular from 5 to 50% by weight, of the active substance. The active substances are employed in a purity of from 90% to 100%, preferably 95% to 100% (according to NMR spectrum).

For the treatment of seed, the relevant formulations will, after having been diluted by a factor of two to ten, give active substance concentrations of from 0.01 to 60% by weight, preferably 0.1 to 40% by weight, in the ready-to-use preparations.

The following are examples of formulations:

1. Products for Dilution with Water

### I) Water-Soluble Concentrates (SL, LS)

10 parts by weight of active substance are dissolved in 90 parts by weight of water or a water-soluble solvent. As an alternative, wetters or other adjuvants are added. The active substance dissolves upon dilution with water. This gives a formulation with an active substance content of 10% by weight.

### II) Dispersible Concentrates (DC)

20 parts by weight of active substance are dissolved in 70 parts by weight of cyclohexanone with addition of 10 parts by weight of a dispersant, for example polyvinylpyrrolidone. The active substance content is 20% by weight. Dilution with water gives a dispersion.

### III) Emulsifiable Concentrate (EC)

15 parts by weight of active substance are dissolved in 75 parts by weight of xylene with addition of calcium dodecylbenzenesulfonate and castor oil ethoxylate (in each case 5 parts by weight). The formulation has an active substance content of 15% by weight. Dilution with water gives an emulsion.

### IV) Emulsions (EW, EO, ES)

25 parts by weight of active substance are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. The formulation has an active substance content of 25% by weight.

### V) Suspensions (SC, OD, FS)

In an agitated ball mill, 20 parts by weight of active substance are comminuted with addition of 10 parts by weight of dispersants and wetters and 70 parts by weight of water or an organic solvent to give a fine active substance suspension. The active substance content in the formulation is 20% by weight. Dilution with water gives a stable suspension of the active substance.

### VI) Water-Dispersible Granules and Water-Soluble Granules (WG, SG)

50 parts by weight of active substance are ground finely with addition of 50 parts by weight of dispersants and wetters and made into water-dispersible or water-soluble granules by means of technical appliances (for example extrusion, spray tower, fluidized bed). The formulation has an active substance content of 50% by weight. Dilution with water gives a stable dispersion or solution of the active substance.

### VII) Water-Dispersible Powders and Water-Soluble Powders (WP, SP, SS, WS)

75 parts by weight of active substance are ground in a rotor-stator mill with addition of 25 parts by weight of dispersants, wetters and silica gel. The active substance content of the formulation is 75% by weight. Dilution with water gives a stable dispersion or solution of the active substance.

### VIII) Gel Formulations (GF)

In a ball mill, 20 parts by weight of active substance, 10 parts by weight of dispersant, 1 part by weight of gelling agent and 70 parts by weight of water or of an organic solvent are mixed to give a fine suspension.

### 2. Products to be Applied Undiluted

### IX) Dusts (DP, DS)

5 parts by weight of active substance are ground finely and mixed intimately with 95 parts by weight of finely divided kaolin. This gives a tracking powder with an active substance content of 5% by weight.

### X) Granules (GR, FG, GG, MG)

0.5 parts by weight of active substance are ground finely and associated with 95.5 parts by weight of carriers. Current methods here are extrusion, spray-drying or the fluidized bed. This gives granules to be applied undiluted with an active substance content of 0.5% by weight.

### XI) ULV Solutions (UL)

10 parts by weight of active substance are dissolved in 90 parts by weight of an organic solvent, for example xylene. This gives a product to be applied undiluted with an active substance content of 10% by weight.

Suitable formulations for the treatment of seeds are, for example:

I water-soluble concentrates (LS)

III emulsifiable concentrates (EC)

IV emulsions (ES)

V suspensions (FS)

VI water-dispersible granules and water-soluble granules (SG)

VII water-dispersible powders and water-soluble powders (WS, SS)

VIII gel formulations (GF)

IX dusts and dust-like powders (DS)

For the treatment of seed, it is preferred to use FS formulations. Usually, such formulations comprise from 1 to 800 g/l active substance, 1 to 200 g/l surfactants, 0 to 200 g/l antifreeze agent, 0 to 400 g/l binder, 0 to 200 g/l colorants and solvents, preferably water.

Preferred FS formulations of the active compounds A and B for the treatment of seed usually comprise from 0.5 to 80% of active compound, from 0.05 to 5% of wetting agent, from 0.5 to 15% of dispersant, from 0.1 to 5% of thickener, from 5 to 20% of antifreeze agent, from 0.1 to 2% of antifoam, from 1 to 20% of pigment and/or dye, from 0 to 15% of tackifier or adhesive, from 0 to 75% of filler/vehicle, and from 0.01 to 1 % of preservative.

Suitable pigments or dyes for formulations of the active compounds A and B for the treatment of seed are Pigment blue 15:4, Pigment blue 15:3, Pigment blue 15:2, Pigment blue 15:1, Pigment blue 80, Pigment yellow 1, Pigment yellow 13, Pigment red 112, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Suitable wetting agents and dispersants are in particular the surfactants mentioned above. Preferred wetting agents are alkylnaphthalenesulfonates, such as diisopropyl- or diisobutylnaphthalenesulfonates. Preferred dispersants are nonionic or anionic dispersants or mixtures of nonionic or anionic dispersants. Suitable nonionic dispersants are in particular ethylene oxide/propylene oxide block copolymers, alkylphenol polyglycol ethers and also tristryrylphenol polyglycol ether, for example polyoxyethylene octylphenol ether, ethoxylated isooctylphenol, octylphenol, nonylphenol, alkylphenol polyglycol ethers, tributylphenyl polyglycol ether, tristerylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters and methylcellulose. Suitable anionic dispersants are in particular alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, lignosulfonates, lignosulfite waste liquors, phosphated or sulfated derivatives of methylcellulose and polyacrylic acid salts.

Suitable for use as antifreeze agents are, in principle, all substances which lower the melting point of water. Suitable antifreeze agents include alkanols, such as methanol, ethanol, isopropanol, the butanols, glycol, glycerol, diethylene glycol and the like.

Suitable thickeners are all substances which can be used for such purposes in agrochemical compositions, for example cellulose derivatives, polyacrylic acid derivatives, xanthane, modified clays and finely divided silica.

Suitable for use as antifoams are all defoamers customary for formulating agrochemically active compounds. Particularly suitable are silicone antifoams and magnesium stearate.

Suitable for use as preservatives are all preservatives which can be employed for such purposes in agrochemical compositions. Dichlorophene, isothiazolenes, such as 1,2-benzisothiazol-3(2H)-one, 2-methyl-2H-isothiazol-3-one hydrochloride, 5-chloro-2-(4-chlorobenzyl)-3(2H )-isothiazolone, 5-chloro-2-methyl-2H-isothiazol-3-one, 5-chloro-2-methyl-2H-isothiazol-3-one, 5-chloro-2-methyl-2H-isothiazol-3-one hydrochloride, 4,5-d ichloro-2-cyclohexyl-4-isothiazol in-3-one, 4,5-dichloro-2-octyl-2H-isoth iazol-3-one, 2-methyl-2H-isothiazol-3-one, 2-methyl-2H-isothiazol-3-one calcium chloride complex, 2-octyl-2H-isothiazol-3-one, and benzyl alcohol hemiformal may be mentioned by way of example.

Adhesives/tackifiers are added to improve the adhesion of the effective components on the seed after treating. Suitable adhesives are EO/PO-based block copolymer surfactants, but also polyvinyl alcohols, polyvinyl pyrrolidones, polyacrylates, polymethacrylates, polybutenes, polyisobutenes, polystyrene, polyethyleneamines, polyethyleneamides, polyethyleneimines (Lupasol®, Polymin®), polyethers and copolymers derived from these polymers.

For treating the seed, it is possible in principle to use any customary methods for treating or dressing seed. Specifically, the treatment is carried out by mixing the seed with the particular amount desired of seed dressing formulations either as such or after prior dilution with water in an apparatus suitable for this purpose, for example a mixing apparatus for solid or solid/liquid mixing partners, until the composition is distributed uniformly on the seed. If appropriate, this is followed by a drying operation.

The components A and B can be formulated jointly or separately.

The use of the combination employed according to the invention of compound A and at least one fungicide from group B for controlling harmful fungi is generally carried out by treating the fungi or the seeds, plants, parts of plants, soils, surfaces, spaces or materials to be protected against fungal attack with a fungicidally effective amount of the combination of these active compounds. The treatment is preferably carried out by bringing the fungi or the seeds, plants, parts of plants, soils, surfaces, spaces or materials to be protected against fungal attack in contact with both active compounds or with a composition comprising both active compounds. To this end, the composition or the individual active compounds are applied to the fungi or the seeds, plants, parts of plants, soils, surfaces, spaces or materials to be protected against fungal attack. Thus, the components A and B can be applied jointly or separately. In the case of separate application, the individual active substances can be applied simultaneously or—as part of a treatment sequence—in succession one after the other, where in the case of successive application the active substances are preferably applied at an interval of from a few minutes up to several days.

The treatment can be carried out both before (preventive) and after (curative) the infection of the materials, plants, seeds, soils, areas or spaces by the fungi.

In crop protection, the fungicidally active components A and B can be applied before, during or after emergence of the plants.

The compositions according to the invention have excellent activity against a broad spectrum of harmful fungi (plant-pathogenic fungi, phytopathogenic fungi), in particular from the class of the Ascomycetes, Deuteromycetes, Peronosporomycetes (synonym Oomycetes) and Basidiomycetes. Some of them are systemically active and can be used in crop protection as foliar fungicides, as fungicides for seed dressing and as soil-acting fungicides.

They are particularly important for controlling a large number of fungi on various crop plants, such as cereals (for example barley, rice, rye, soybean, corn, wheat, oats), pome fruit and stone fruit (for example apple, pear, quince, sweet cherries, sour cherries, plum, quetsch, peach, nectarine, apricot, almond), vegetables (for example cucumbers, beans, tomatoes, potatoes and cucurbits), pulses (for example beans, peas, lentils), cotton, grass, bananas, peanuts, coffee, grapevines, ornamental plants, sugar cane and on a large number of seeds.

They are particularly suitable for the control of the following phytopathogenic fungi:

Alternaria species on vegetables, rapeseed, sugar beet and fruit and rice,

Aphanomyces species on sugar beet and vegetables,

Bipolaris and Drechslera species on corn, cereals, rice and lawns,

Blumeria graminis (powdery mildew) on cereals,

Botrytis cinerea (gray mold) on strawberries, vegetables, flowers and grapevines,

Bremia lactucae on lettuce,

Cercospora species on corn, soybean, rice and sugar beet,

Cochliobolus species on corn, cereals, rice (e.g., Cochliobolus sativus on cereals, Cochliobolus miyabeanus on rice),

Colletotricum species on soybean and cotton,

Drechslera species on cereals and corn,

Exserohilum species on corn,

Erysiphe cichoracearum and Sphaerotheca fuliginea on cucurbits,

Fusarium and Verticillium species on various plants,

Gaeumanomyces graminis on cereals,

Gibberella species on cereals and rice (e.g., Gibberella fujikuroi on rice),

Grainstaining complex on rice,

Helminthosporium species on corn and rice,

Michrodochium nivale on cereals,

Mycosphaerella species on cereals, bananas and peanuts,

Phakopsara pachyrhizi and Phakopsara meibomiae on soybeans,

Phomopsis species on soybeans and sunflowers,

Phytophthora infestans on potatoes and tomatoes,

Plasmopara viticola on grapevines,

Podosphaera leucotricha on apples,

Pseudocercosporella herpotrichoides on cereals,

Pseudoperonospora species on hops and cucurbits,

Puccinia species on cereals and corn,

Pyrenophora species on cereals,

Pyricularia oryzae, Corticium sasakii, Sarocladium oryzae, S. attenuatum, Entyloma oryzae on rice,

Pyricularia grisea on lawns and cereals,

Pythium spp. on lawns, rice, corn, cotton, rapeseed, sunflowers, sugar beet, vegetables and other plants,

Rhizoctonia species on cotton, rice, potatoes, lawns, corn, rapeseed, potatoes, sugar beet, vegetables and other plants,

Sclerotinia species on rapeseed and sunflowers,

Septoria tritici and Stagonospora nodorum on wheat,

Erysiphe (syn. Uncinula) necator on grapevines,

Setospaeria species on corn and lawns,

Sphacelotheca reilinia on corn,

Thievaliopsis species on soybeans and cotton,

Tilletia species on cereals,

Ustilago species on cereals, corn and sugar beet, and

Venturia species (scab) on apples and pears.

The mixtures according to the invention are particularly preferred for controlling Botrytis species in grapevine and vegetable crops and also in ornamental plants, and for controlling Pyrenophora species in cereals. Specifically, they are used for controlling Pyrenophora species, such as Pyrenophora graminea, Pyrenophora tritici-repentis and especially Pyrenophora teres (Drechsler) in barley.

The fungicidally active composition according to the invention can also be used for controlling harmful fungi in the protection of materials (for example of wood, paper, paint dispersions, fibers or fabrics) and in the protection of stored products, for example against Paecilomyces variotii.

In crop protection, the required application rate of pure active compound composition, i.e. A and B without formulation auxiliaries, depends on the composition of the plant stand, on the development stage of the plants, on the climatic conditions at the application site and on the application method. In general, the total amount of A and B applied is from 0.001 to 3 kg/ha, preferably from 0.005 to 2 kg/ha and in particular from 0.01 to 1 kg/ha of active substance (a.s.).

The required application rates of compound A are generally in the range from 0.1 g/ha to 1 kg/ha and preferably in the range from 1 g/ha to 500 g/ha or from 5 g/ha to 500 g/ha of a.s.

The compositions are preferably applied to the plants by spraying the leaves. Here, application can be carried out, for example, by customary spray techniques using spray liquor amounts of from about 100 to 1000 l/ha (for example from 300 to 400 l/ha) using the carrier water. Application of the herbicidal compositions by the low-volume and ultra-low-volume method is possible, as is their application in the form of microgranules.

In the treatment of seed, the amounts of active compound used (the total amounts of active compounds of fungicides A) and B)) are from 1 to 1000 g/100 kg of seed, preferably from 1 to 750 g/100 kg, in particular from 5 to 500 g/100 kg.

In the application in the protection of materials and stored products, the application rate of active compounds A) and B) depends on the area of use and the desired effect. Customary total application rates in the protection of materials are, for example, from 0.001 g to 2 kg, preferably from 0.005 g to 1 kg, of fungicides A) and B) per cubic meter of treated materials.

Surprisingly, the compositions according to the invention comprising the compound of the formula A and at least one fungicide from component B have better fungicidal activity against harmful fungi than would have been expected based on the fungicidal activity of the individual compounds, i.e. the fungicidal activity is increased in a superadditive manner. The expected efficacies of active compound combinations can be determined, for example, using Colby's formula (S. R. Colby, Calculating Synergistic and Antagonistic Response of Herbicide Combinations, Weeds, 15, pp. 20-22). This means that by using the compound A jointly with at least one fungicide B, an enhanced activity against at least one harmful fungi in the sense of a synergistic effect (synergism) is achieved. For this reason, the compositions may be employed in lower total application rates.

### EXAMPLES

The synergistic activity of the composition according to the invention can be demonstrated by the tests below.

The active compounds were used either as a commercial formulation or employed as a stock solution. The stock solution was prepared from 25 mg of active compound which had been made up to 10 ml using a mixture of acetone and/or DMSO as solvent and the emulsifier Uniperol® EL (wetting agent having emulsifying and dispersing action based on ethoxylated alkylphenols) in a volume ratio of solvent to emulsifier of 99:1. The volume was then made up to 100 ml using water.

Evaluation was carried out by visually determining the infected leaf areas in %. These percentages were converted into efficacies in % of the untreated control. At an efficacy of 0, the infection of the treated plants corresponds to that of the untreated control plants; at an efficacy of 100, the treated plants are not infected.

The expected efficacies for active compound combinations were determined using Colby's formula (Colby, S. R., “Calculating synergistic and antagonistic responses of herbicide combinations”, Weeds, 15, pp. 20-22, 1967) and compared to the observed efficacies.

Colby's formula: E=x+y−xy/100

E expected efficacy, expressed in % of the untreated control, when using the mixture of the active compounds A and B at the concentrations a and b

x efficacy, expressed in % of the untreated control, when using the active compound A at the concentration a

y efficacy, expressed in % of the untreated control, when using the active compound B at the concentration b

Activity against net blotch of barley caused by Pyrenophora teres, 2-day protective application

Leaves of potted barley seedlings of the cultivar “Hanna” were sprayed to runoff point with an aqueous suspension having the concentration of active compound stated below. 48 hours after the spray coating had dried on, the test plants were inoculated with an aqueous spore suspension of Pyrenophora teres (synonym Drechslera teres), the net blotch pathogen. The test plants were then placed in a greenhouse at temperatures between 20 and 24° C. and 95 to 100% relative humidity. After 6 days, the extent of the development of the disease was determined visually in % infection of the total leaf area.

TABLE A
Activity of the individual active compounds

| | Concentration in the | Efficacy |
|---|---|---|
| Active compound | spray liquor [ppm] | [%] |
| control (untreated) | — | — |
| | | (90% infection) |
| compound A | 4 | 22 |
| | 0 | 0.5 |
| metiram | 250 | 0 |

TABLE B
Activity of the composition according to the invention

| | Conc. spray | | Calculated | Observed |
|---|---|---|---|---|
| Active compound | liquor | Mixing | efficacy* | efficacy |
| combination | [ppm] | ratio | [%] | [%] |
| compound A + | 4 | 1:62.5 | 22 | 44 |
| metiram | 250 | | | |

*according to Colby

As can be seen from the results, the compositions according to the invention act synergistically.

1-13. (canceled)

14. A fungicidally active composition, comprising:
A) N-[2-(1,3-dimethylbutyl)-3-thienyl]-1-methyl-3-(trifluoromethyl)-1H-pyrazole-4-carboxamide of the formula A 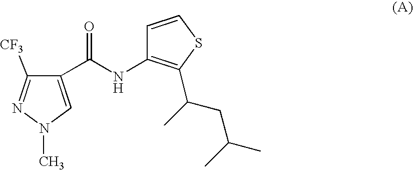
and
B) at least one further fungicide selected from
B. 1) ethaboxam;
B.2) carboxamide fungicides selected from the group consisting of zoxamide, fluopicolide, thifluzamide, carboxin, boscalid, fenhexamid, tiadinil, flumorph, mandipropamid, fenoxanil, silthiofam, N-(2-(4-[3-(4-chlorophenyl)prop-2-ynyloxy]-3-methoxyphenyl)ethyl)-2-methylsulfonylamino-3-methylbutyramide of the formula
B.2.1 (R=methyl), N-(2-(4-[3-(4-chlorophenyl)prop-2-ynyloxy]-3-methoxyphenyl)ethyl)-2-ethylsulfonylamino-3-methylbutyramide of the formula
B.2.1 (R=ethyl) 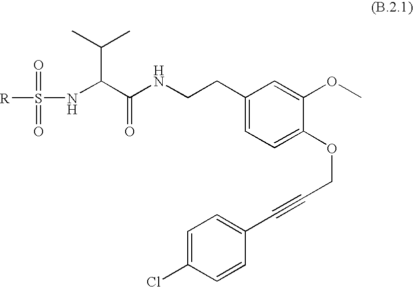
(R=methyl, ethyl)
and N-(2-cyanophenyl)-3,4-dichloroisothiazole-5-carboxamide of the formula B.2.2 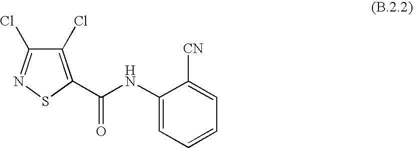
B.3) heterocyclic compounds selected from the group consisting of famoxadone, fenamidone, proquinazid, acibenzolar-S-methyl, 2-butoxy-6-iodo-3-propylchromen-4-one of the formula B.3.1 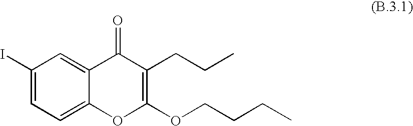
N,N-dimethyl-3-(3-bromo-6-fluoro-2-methylindole-1-sulfonyl)[1,2,4]triazole-1-sulfonamide of the formula B.3.2 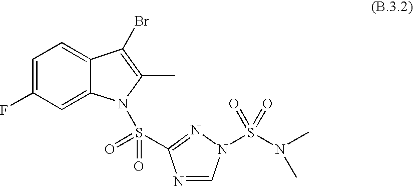
and 3-[5-(4-chlorophenyl)-2,3-dimethylisoxazolidin-3-yl]pyridine of the formula B.3.3 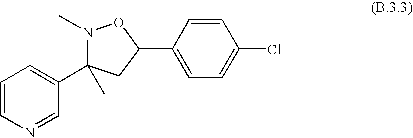
B.4) carbamate and dithiocarbamate fungicides selected from the group consisting of metiram, propamocarb, propamocarb hydrochloride, iprovalicarb, benthiavalicarb, the carbamate of the formula B.4.1 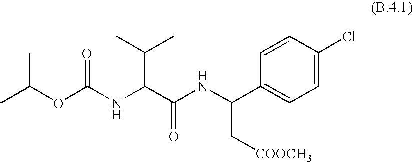
and 4-fluorophenyl N-(1-(1-(4-cyanophenyl)ethanesulfonyl)but-2-yl)carbamate of the formula B.4.2 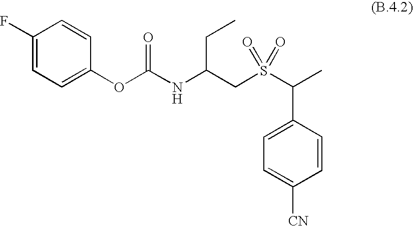
B.5) other fungicides B selected from
B.5.1) dithianon;
B.5.2) tolclofos-methyl;
B.5.3) organochlorine compounds selected from flusulfamide and tolylfluanid;
B.5.4) other fungicides selected from the group consisting of spiroxamine, cyflufenamid and metrafenone.

15. The composition according to claim 14 where the at least one fungicide B is selected from carbamate and dithiocarbamate fungicides of group B.4).

16. The composition according to claim 15, where the at least one fungicide B is selected from metiram, iprovalicarb and benthiavalicarb.

17. The composition according to claim 14, where the at least one fungicide B is ethaboxam.

18. The composition according to claim 14, where the at least one fungicide B is selected from fenhexamide and zoxamide.

19. The composition according to claim 14 where the at least one fungicide B is selected from proquinazid and 2-butoxy-6-iodo-3-propylchromen-4-one of the formula B.3.1.

20. The composition according to claim 14, where the at least one fungicide B is dithianon.

21. The composition according to claim 14, where the at least one fungicide B is selected from cyflufenamide and metrafenone.

22. The composition according to claim 14 where the weight ratio of component A) to component B) is from 100:1 to 1:100.

23. The composition according to claim 14, furthermore comprising at least one inert liquid and/or solid carrier and, if appropriate, at least one surfactant and/or at least one customary auxiliary.

24. A 2-component kit, comprising a first component comprising the compound of formula A which is defined as in claim 14, a liquid or solid carrier and, if appropriate, at least one surfactant and/or at least one customary auxiliary, and a second component comprising at least one fungicide B which is defined as in claim 14, a liquid or solid carrier and, if appropriate, at least one surfactant and/or at least one customary auxiliary.

25. A method for controlling harmful fungi, which comprises allowing the composition according to the definition in claim 14 to act on the fungi, their habitat or the materials, plants, seed or soils to be protected against fungal attack.

26. The method according to claim 25, where the fungicidally active components A) and B) of the composition are applied simultaneously, that is jointly or separately, or in succession.

27. The use of the composition according to the definition in claim 14 for controlling harmful fungi.
